(19) United States
(12) Patent Application Publication
(10) Pub. No.: US 2010/0050085 A1
(43) Pub. Date: Feb. 25, 2010

(54) SYSTEM FOR PROCESSING, DERIVING AND DISPLAYING RELATIONSHIPS AMONG PATIENT MEDICAL PARAMETERS

(75) Inventors: George T. Blike, Grantham, NH (US); M. Christina De Mur, Andover, MA (US)

Correspondence Address: Rissman Jobse Hendricks & Oliverio, LLP, 100 Cambridge Street, Suite 2101, Boston, MA, 02114, US

(73) Assignee: DRAEGER MEDICAL SYSTEMS, INC., Andover, MA (US)

(21) Appl. No.: 12/442,759

(22) PCT Filed: Sep. 28, 2007
(86) PCT No.: PCT/US2007/079931

§ 371 Date: Oct. 7, 2009

Related U.S. Application Data
(60) Provisional application No. 60/827,553, filed on Sep. 29, 2006.

(51) Int. Cl. G06F 17/30; G06F 3/048

(52) U.S. Cl. 715/738; 707/731; 706/48; 707/E17.014

(57) ABSTRACT

A system and method for obtaining and deriving medical data related to patient inspiratory and cxpiratory flows and for displaying the data. A data acquisition processor acquires patient medical data related to inspiratory and expiratory volume from a ventilator. A data processor maps the data related to inspiratory and expiratory flow onto a flow data object. A display displays the flow data object comprising inspiratory objects for displaying information representative of the inspiratory flow and expiratory objects for displaying information representative of the expiratory flow.

### RELATED APPLICATIONS

This application claims the benefit of U.S. Provisional Application Ser. No. 60/827,553, filed Sep. 29, 2006.

### FIELD OF THE TECHNOLOGY

This invention is related to the processing and presentation of medical data and, more particularly, to a system for deriving and displaying relationships among acquired and calculated patient medical parameters associated with specific physiological processes.

### BACKGROUND

In hospitals and other health care environments, it is typically necessary or desirable to collect and display a variety of medical data associated with a patient. Such information may include, but is not limited to, vital sign data, care unit data, diagnosis and treatment procedures, ventilator information, and other parameter data associated with a given patient. Presently, such information is often provided via a chart, located at a patient's bedside or at an attendant's station, or via a medical display image or system which can be located either locally or remotely to the patient.

Medical display systems are increasingly employed to provide information to physicians and other care providers in a clinical setting. Typical display systems provide data in the form of numbers and one-dimensional signal waveforms that must be assessed, in real time, by the care provider. Alarms are sometimes included with such systems to warn the physician of an unsafe condition, such as when a parameter exceeds a threshold value. In the field of anesthesiology, for example, the anesthesiologist must monitor the patient's condition and at the same time recognize problems, identify the cause of the problems, and take corrective action during the administration of the anesthesia. An error in judgment can be fatal. Displays of data conveying the patient's physiologic condition therefore play a central role in allowing surgeons and anesthesiologists to observe problem states in their patients and deduce the most likely causes of the problem state during surgery, thus allowing expeditious treatment.

Many important issues in the provision of medical data arise directly from the need to correctly allocate the attention of the medical care provider. Activities vying for the care provider's attention include monitoring the patient, resource management, action scheduling, action planning, action implementation, re-evaluation of actions and decisions, prioritization of problems and activities, observation, problem recognition, and data verification. Key issues include avoidance of “fixation errors” and quick identification of side effects or misdiagnosis. In order to optimize the use of the care provider's attention, medical data needs to be provided in a form that maximizes the information value received by, while minimizing the time and actions required from, the care provider. Specific issues for the presentation of medical data include which data streams to provide, how often specific data streams should be provided, how often data streams should be updated, how data streams should be presented, what relationships between data streams should be presented, how relationships between data streams should be presented, and the level of abstraction at which data should be presented. Further, a fully-functional medical data system optimally will provide verification of data presented, identification of artifacts and transient data, problem recognition and identification, presentation of the effects of specific actions, and prediction of future states.

For the most part, the current ability to collect data on a patient has outpaced the usability of that data. The complexity and volume of the data available, as well as that of the relationships of available data to other available data, can overwhelm human capabilities to interpret and thus be a source of errors in decision-making. Overall, information displays that show the quantitative (data value), qualitative (high, low, normal zones for the parameter), temporal (trending and change over time), and relational (manner in which multiple parameters relate to disease states that need treatment) information that clinicians need in an intuitive manner are currently lacking. For example, comprehensive data related by physiologic systems is typically not provided on a single screen, if available at all. Redundant measures of the same parameter, if available, are typically not displayed proximate to each other. Trends may be available, but individual raw parameters are generally trended on a large table and often require some amount of navigation within a user interface. Control limits or boundaries, if visible at all, are usually small in font size. Complex relationships are typically presented only in tabular form. Existing systems further typically require complex skills and training to be used proficiently by medical care providers. Consequently, the need exists for a more intuitive, effective, user friendly, adaptive display interface for providing patient parameters and associated data to a clinician.

### SUMMARY

In accordance with principles of the present invention, a system and method for obtaining and deriving medical data related to patient inspiratory and expiratory flows and for displaying the data. A data acquisition processor acquires patient medical data related to inspiratory and expiratory volume from a ventilator. A data processor maps the data related to inspiratory and expiratory flow onto a flow data object. The flow data object comprising inspiratory objects for displaying information representative of the inspiratory flow and expiratory objects for displaying information representative of the expiratory flow is displayed by a display.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a conceptual view of an embodiment of a display architecture according to one aspect of the present invention;

FIG. 2 is an example data box presenting quantitative, qualitative, and temporal displays of data;

FIG. 3 is functional representation of a preferred embodiment of a system according to one aspect of the present invention;

FIGS. 4A and 4B depict example screen shots from an embodiment of a display system organized by physiologic process, according to one aspect of the present invention;

FIG. 5 is an example embodiment of a data display for ventilation, depicting a bronchospasm event, according to an aspect of the present invention;

FIG. 6 is an example embodiment of another data display for ventilation, depicting the bronchospasm event, according to an aspect of the present invention;

FIG. 7 is an example embodiment of a trend display, depicting a bronchospasm event, according to an aspect of the present invention;

FIG. 8 is an example embodiment of a graphical display for ventilation, depicting the baseline before a bronchospasm event, according to an aspect of the present invention;

FIGS. 9A-B depict an example embodiment of a graphical display, depicting the bronchospasm event, according to an aspect of the present invention;

FIG. 10 is an example embodiment of a data display for ventilation, depicting Adult Respiratory Distress Syndrome (ARDS), according to an aspect of the present invention;

FIG. 11 is an example embodiment of another data display for ventilation, depicting Adult Respiratory Distress Syndrome, according to an aspect of the present invention;

FIG. 12 is an example embodiment of a trend display, depicting Adult Respiratory Distress Syndrome, according to an aspect of the present invention;

FIG. 13 is an example embodiment of a graphical display, depicting Adult Respiratory Distress Syndrome, according to an aspect of the present invention;

FIG. 14 is an example embodiment of a data display for perfusion, shown in conjunction with real-time results being received from one or more monitoring devices, according to an aspect of the present invention;

FIG. 15 is another example embodiment of a trend display, presenting boundary information, according to an aspect of the present invention;

FIG. 16 is an example embodiment of a trend display that indicates when the value of a parameter has entered a predetermined alert zone for that parameter, according to an aspect of the present invention;

FIG. 17 is an example embodiment of a portion of a trend display that depicts ± confidence interval information, according to another aspect of the present invention;

FIG. 18 is a flowchart depicting an embodiment of the overall processing and derivation steps employed in presenting patient parameters via an embodiment of the system of the present invention; and

FIG. 19 is a flowchart depicting an embodiment of the dynamic processing and derivation steps employed in dynamically presenting patient parameters via an embodiment of the data display of the present invention.

### DETAILED DESCRIPTION

In a multidimensional display architecture according to one aspect of the present invention, acquired physiologic data is related and integrated by physiological process, via a functional mapping, rather than by the source of the data or by organ system. The present invention transforms raw data into cognitively useful information about the patient's physiological status. Through the data visualization process of the present invention, data is presented in a manner that enhances the decision-making abilities of the care provider, and further allows actions to be easily monitored for side effects.

A display architecture according to one aspect of the present invention uses multiple dimensions of organization to improve the clinical utility of the available data streams: physiological systems from whole to parts, and levels of integration from raw data elements to multidimensional graphical representations. This architecture provides clinicians with an organization of complex sets of physiological data, such as that typically available through systems provided by many vendors, into a multidimensional set of views that are mapped onto the cognitive decision-making strategies used by critical care clinicians performing control tasks.

The system of the present invention brings in data representing values of patient medical parameters from many different medical sensor devices to have calculations performed by the system, after which the acquired patient medical parameters and results of calculations, i.e., derived calculations of patient medical parameters, related to a particular physiologic process are assembled and presented in a cognitively useful manner. Data is represented at the data display level of the present invention as subsets of important variables that are most relevant to a particular physiologic function. Temporal relations, trend information, qualitative assessments, and physiologic dynamics are further provided through complex relational graphics at the trend and graphical display levels.

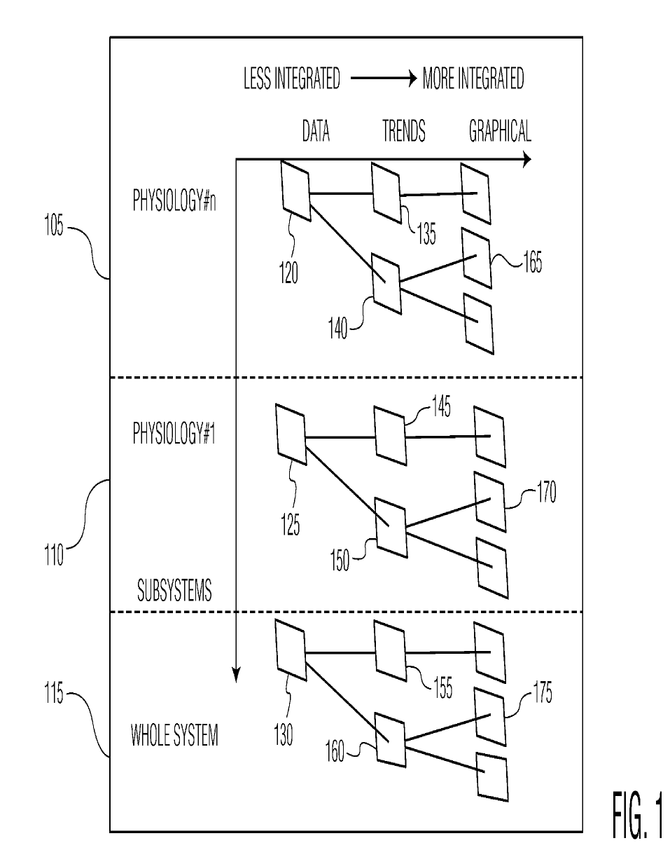

FIG. 1 presents a conceptual view of an embodiment of the architecture of the present invention. In FIG. 1, data is grouped by individual physiology subsystem 105, 110 and presented in screens having organizational levels that are successively less integrated to more integrated. Similarly, subsystem data may further be co-organized at the whole system physiology level 115 and presented in additional screens that also have organizational levels that are successively less integrated to more integrated. At the lowest integration level, the “data” level 120, 125, 130, individual quantitative data values and patient medical parameters are organized and presented in a relational display that conveys the interrelationships between the individual data values and types. At the second integration level, the “trend” level 135, 140, 145, 150, 155, 160, the qualitative and temporal relationships between the quantitative data are presented. At the highest integration level, the “graph” level 165, 170, 175, the quantitative, qualitative, and temporal relationships are organized into a contextual graphic display that presents information about the ongoing state of the physiology subsystem in a manner designed to cognitively reflect the way in which the medical care provider visualizes the physiologic subsystem. At all levels, the present invention cognitively provides and amplifies relational information, such as interactions, complex connections, and side effects, as well as to provide the information in an ergonomically effective manner, such as, but not limited to, providing a consistent interface and visibility at typical use distances.

It is well understood in the art of data presentation that display format is extremely important to the viewer's perception and understanding of the data presented [see, e.g., Blike, George T. et al., “A graphical object display improves anesthesiologists' performance on a simulated diagnostic task”, Journal of Clinical Monitoring and Computing 15: 37-44, 1999; Blike, George T. et al., “Specific elements of a new hemodynamics display improves the performance of anesthesiologists”, Journal of Clinical Monitoring and Computing 16: 485-491, 2000]. Cognitive systems engineering therefore focuses on optimizing the “fit” between humans and data in order to optimize decision-making. Cues to patient state typically include quantitative data (e.g., numeric values), qualitative data (e.g., boundaries, “high”/“low”/“normal”), and temporal data (direction and rate of change over time).

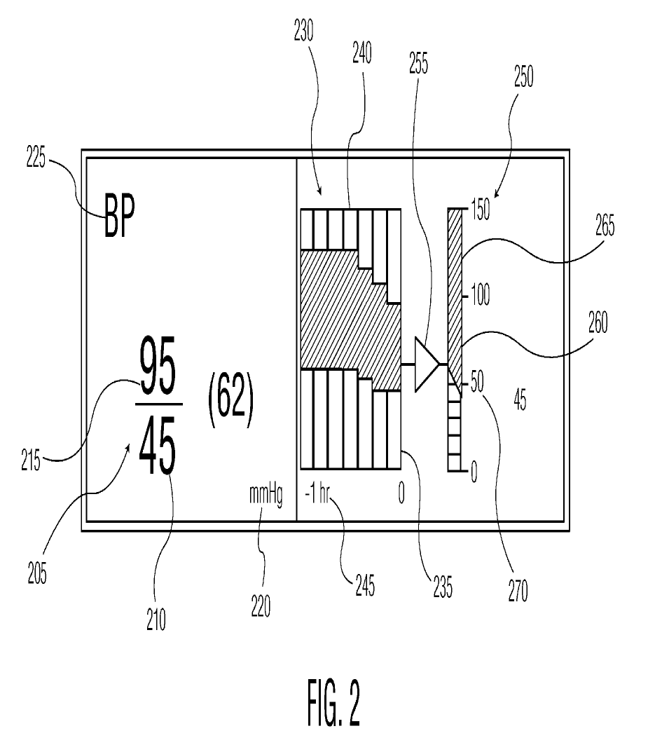

Examples of displays having these cues are shown in the example data box depicted in FIG. 2. In FIG. 2, quantitative blood pressure data 205 is presented through a display of the relevant data values 210, 215, units 220, and label 225 identifying the specific data being displayed. Temporal blood pressure data 230 is presented via bar graph 235 having time grid 240 and time scale 245. Qualitative data 250 is presented via value pointer 255, reference scale 260, warning zone 265, and alarm limit 270.

While quantitative, temporal, and qualitative cues are useful, they are made much more so by the addition of relational data, i.e. by the representation of data to data relationships that create patterns that are clinically relevant. High order physiology such as, but not limited to, flow, pressure, or resistance, is normally reflected in multiple data streams, so that the overall physiologic effect in the patient can only be understood through the relationship of these data streams to each other. These relationships are reflected in the specialized semantic descriptors (language) used by clinicians (e.g., hypertensive vs. hypotensive, high output vs. low output, dilated vs. constricted).

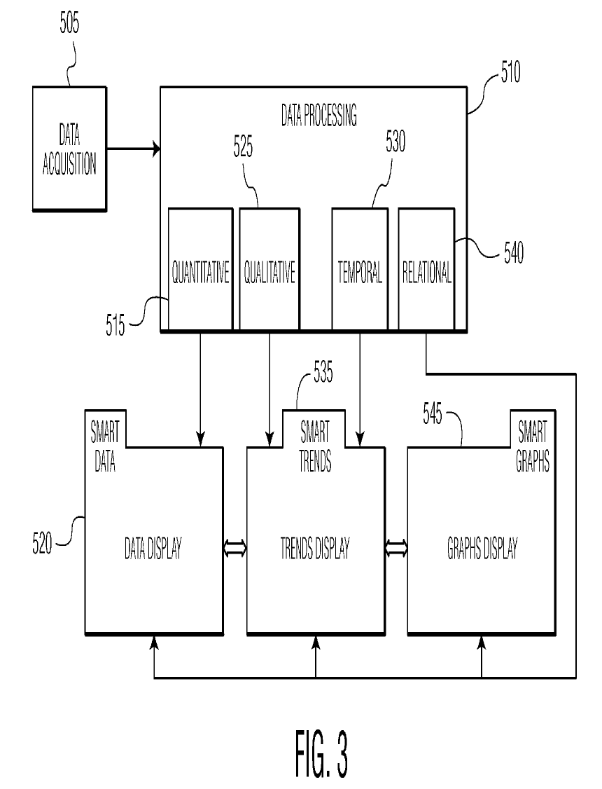

In order to present patient data in the most effective manner possible, raw patient medical parameter data obtained from multiple monitoring sources or devices is acquired and processed, in order to derive the relationships needed to create the various displays. A functional representation of a preferred embodiment of a system for acquiring and processing the data, deriving the relationships, and creating the displays, according to one aspect of the present invention, is depicted in FIG. 3. In FIG. 3, data acquisition processor 503 provides acquired patient medical parameter data, some of which are related to a particular physiological process, to data processor 510. Data processor 510 calculates derived patient medical parameters related to the particular physiological process from the acquired patient medical parameters. Quantitative subsystem 515 of data processor 510 applies predetermined relationship rules, including precedence rules which may determine respective display positions of the acquired and derived patient medical parameter data, to the acquired and derived patient medical parameter data. Quantitative subsystem 515 organizes the patient medical parameter data according to the results of applying the rules, and relationally presents the patient medical parameter data on data display 520 according to the results of applying the rules. At least one physiological relationship between the displayed patient medical parameters is indicated by the respective display positions of the patient medical parameters. Qualitative 525 and temporal 530 subsystems of data processor 510 apply predetermined qualitative and temporal relationship rules, respectively, to the patient medical parameter data, organize the results according to additional relationship rules, and relationally present the organized results on trends display 535. Relational subsystem 540 of data processor 510 applies relationship rules to the quantitative, temporal, and qualitative results, graphically organizes the results, and presents the graphically organized results on graphical display 545. In some embodiments, the relational subsystem 540 maps patient medical parameter data onto one or more data objects before being displayed.

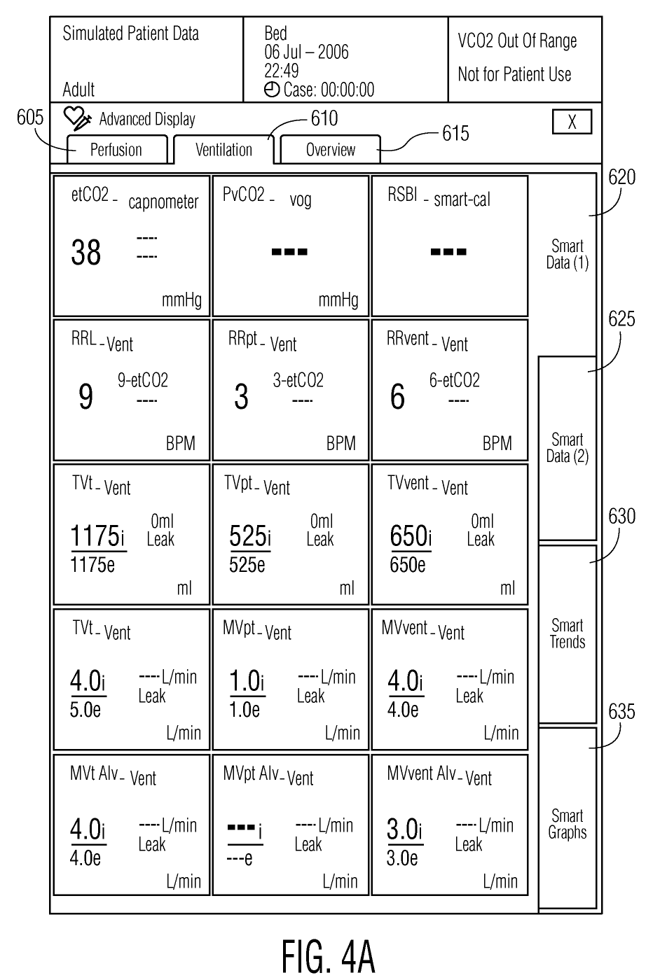

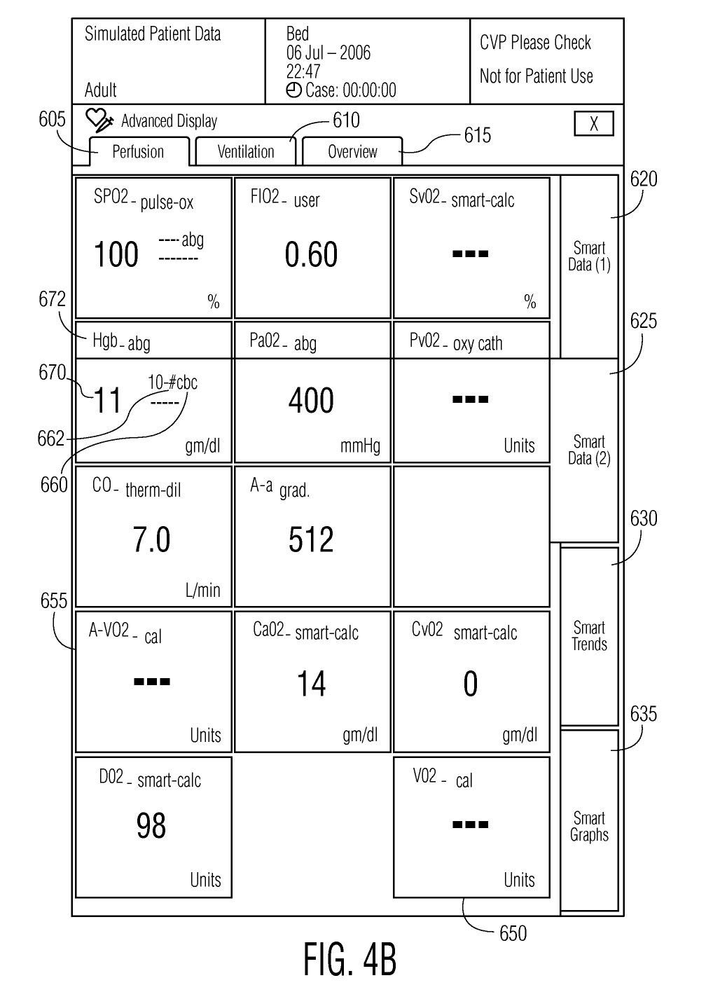

In the preferred embodiment, the system has multidimensional displays that are organized by physiological process. The data display presents all available physiology data for a single subsystem in an organizational format that cognitively makes clinical sense. For example, FIGS. 4A and 4B depict screen shots from an example embodiment of a display system or user interface according to one aspect of the present invention. FIG. 4A depicts an example embodiment of a data display for ventilation and FIG. 4B depicts an example embodiment of a data display for perfusion. As seen in FIGS. 4A and 4B, all of the screens relating to each of the physiologic subsystems, ventilation and perfusion, as well as an optional overview screen (not shown), are accessed by means of horizontal tabs 605, 610, 615 at the top of the display. This aspect of the system of the present invention permits the user to easily access all of the available acquired data and calculated parameters related to any of multiple physiological processes with a single keystroke or mouse click.

In a preferred embodiment of a system according to the present invention, three specific types of displays are available for each physiologic process. These three different types of displays, from least integrated to more integrated, are the data, trend, and graphical displays. Each of these displays are accessible from each display screen by means of vertical side tabs 620, 625, 630, 635, as shown in FIGS. 4A-B. This aspect of the system of the present invention permits the user to easily access all of the available acquired data and calculated parameters related to an individual physiological process with just a single keystroke or mouse click. One skilled in the art will recognize that accessing each of the displays is possible through a variety of alternate display features other than a tab. For example, a hyperlink displayed on the user interface may provide such access.

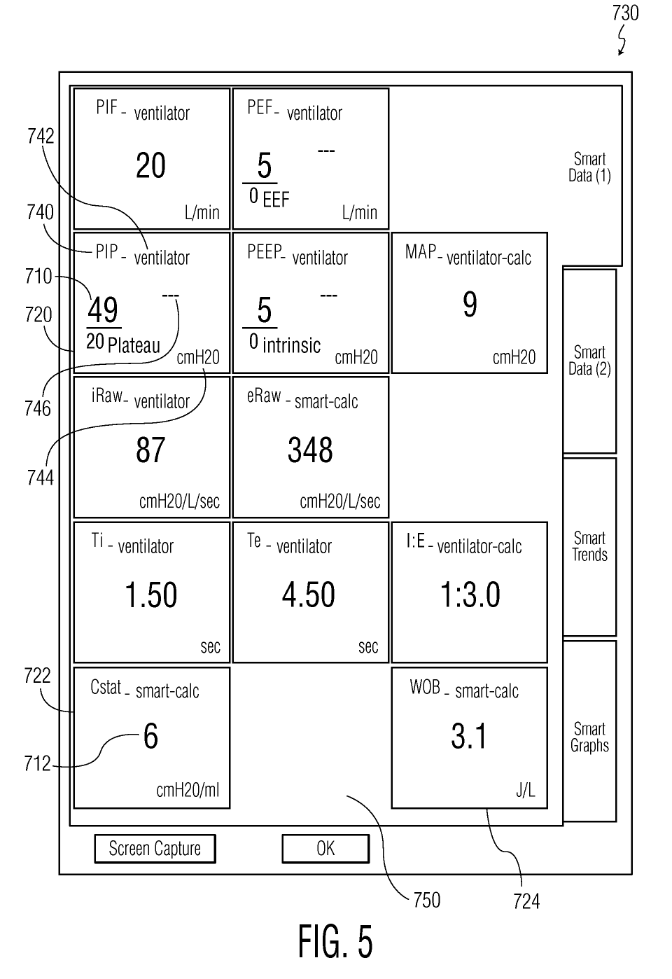

The three types of displays provided by the preferred embodiment of the present invention are most easily illustrated by discussing a specific example set of data and displays for a physiology subsystem. FIG. 5 through FIGS. 9A-B depict example embodiments of displays presenting data related to the ventilation physiologic system, during a period when a bronchospasm event occurs.

FIG. 5 is an example embodiment of a ventilation data display during a bronchospasm event, according to one aspect of the invention. In FIG. 5, parameter values, both acquired 710 and calculated 712, are mapped to a 3×5 grid of parameter data boxes 720, 722, 724 in data display 730. The data display of the present invention is designed around the concept of proximity compatibility, wherein the layout of the boxes, as well as the layout of the parameters displayed within each box, is designed to intuitively convey the relationship between the displayed parameters. In particular, the horizontal and vertical arrangement of the data boxes cognitively accentuates the relationships between the acquired and calculated parameters presented in the boxes.

The boxes are arranged vertically and horizontally and grouped such that the flow information and the pressure information can be easily seen together. Like parameters are horizontally grouped, for example: peak inspiratory flow (PIF) and peak expiratory flow (PEF). The related parameters of flow, pressure, resistance, time, and calculated parameters such as compliance (Cstat) and work of breathing (WOB), are arranged vertically.

In a preferred embodiment, each data box 720 presents primary data value 710, data label 740, data source 742, data units 744, values, if any, from other (redundant) sources of the same data (not shown), no data available indicator 746, if needed, and manual or intermittent indicator, if needed (not shown). Some boxes may present the same type of data, but derived from a different device. In some embodiments, values, scale values, and labels are visible from a distance of at least 6 meters so that they may be more easily viewed by care providers. In an example embodiment, for ergonomic advantage, data is purple, labels and reference information are white, labels for absent data that could be available if a source were connected are grayed out, and dashes are presented for missing data.

Preferably, rules are established for the display of intermittent and missing data that are consistent across all three types of displays. For example, in FIG. 4B, some boxes 650, 655 present parameters for which no data is available, so they are “grayed out”. Among other benefits, this provides a visual cue to the user that additional data could be available if additional monitoring devices were hooked up. Data box positions 750 that are not used at all are generally left blank (FIG. 5). In a preferred embodiment, data that is manually entered, or is otherwise intermittent, is shown as a change in data label, with time elapsed shown over units portion of data box after a predetermined duration of time, e.g., 15 minutes, has passed. Text cueing of current vs. old data is accomplished with a change in shading (white to grey) and symbolic reference (such as, but not limited to, using a # sign in front of the label). An example of this is label 660 in FIG. 4B, wherein the cbc value 660 of 10, a manually entered parameter, is flagged with “#” 662. In addition, the elapsed time (e-time) since the acquired value was obtained may optionally be shown.

In a preferred embodiment, when one or more secondary sources of a parameter are available, the data from these sources is shown within the same data box, to the right of the data from the primary source. This proximity permits easy recognition of any discrepancies. For example, a data box might display both arterial blood pressure and non-invasive blood pressure (NIBP), or heart rate obtained from multiple sources. The preferred embodiment provides all data related to the physiologic process that is available from all sources. For example, in FIG. 4B, Hgb 670 is available both from agb 672 and from cbc 660.

In one embodiment, the system dynamically sets the precedence rules for data sources, determining which source will be used as the primary source for the parameter. Precedence may be established based on any useful criteria such as, for example, the known accuracy and precision of the various sources and/or the present relative accuracy of those sources. Optionally, the system will highlight any discrepancies between values for the same parameter received from multiple sources. The system preferably indicates which device source is being used and what other sources are, or could be, available. In one embodiment of the present invention, where there are multiple sources of the same data parameter available, data from a lower priority source will be dynamically promoted to a higher priority if/when data from any higher priority sources is, or becomes, absent. Similarly, when a higher priority source becomes available during operation of the system, a lower priority source will be demoted in favor of a source with higher precedence. For example, if ECG-HR (ECG heart rate) is initially absent, then SpO2-HR may be displayed in its place. Similarly, if a sensor providing data for a particular parameter were to become disconnected, data from the next higher priority source will be promoted and displayed in its place. In another embodiment, the priority of sources is dynamically determined based on an assessment of their ongoing accuracy, with the measurement provided by the most accurate source at that time being displayed as the highest priority source. For example, a source may be promoted over a higher precedence source if it is currently providing continuous data, versus intermittent data coming from the normally-preferred source.

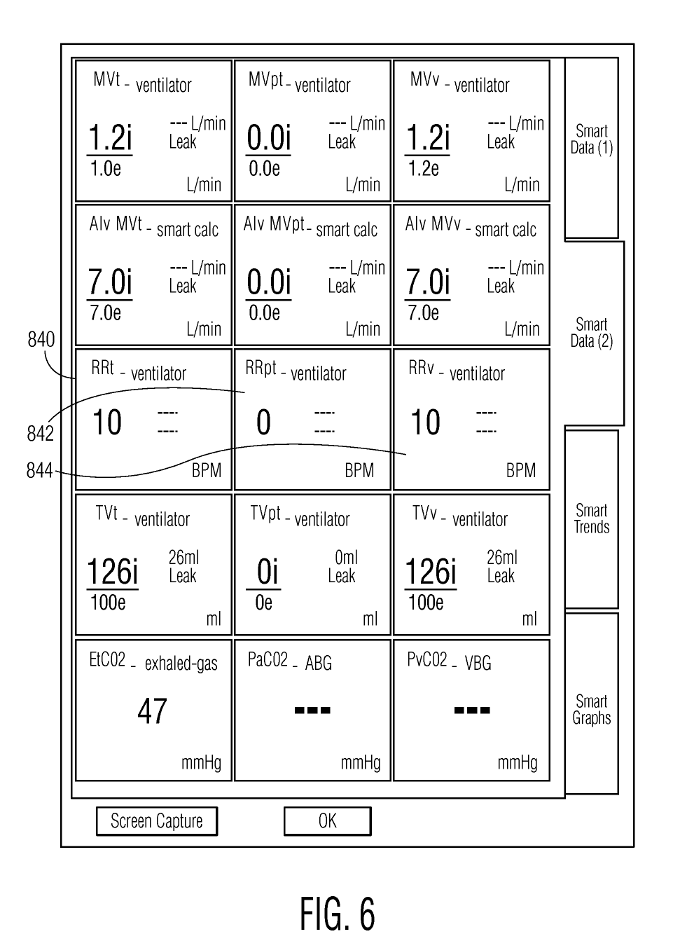

FIG. 6 is an example embodiment of another data display, presenting different ventilation parameters available during the bronchospasm event of FIG. 5.

A particular advantage of the data display of the present invention is that multiple sources of the same physiological variable are presented. For example, as shown in FIG. 6, “total respiratory rate” is shown in box 840 on the left and a relevant subsystem breakdown of respiratory rate into the patient RRpt 842 and ventilator RRv 844 components is shown to the right. Within a single level, for a given parameter such as respiratory rate, all available sources of that parameter may be made visible. For example, there might be four sources of total respiratory rate that could be shown in the same box. The clinical precedence rules (best source when multiple sources are available) are used to chose one of the sources to show large, with the other sources shown to the right in smaller font size text. If a parameter has multiple components such as systolic, diastolic, and mean blood pressure, or inspired and expired Tidal Volumes, all may optionally be shown in the same box, with the more relevant clinical value shown with larger and higher contrast alpha-numeric presentation. Similarly, related subcomponents, such as Alveolar Volumes and Deadspace Volumes, may be presented using the whole-part hierarchy, from top to bottom, in the data display layout.

The horizontal arrangement of total respiratory rate 840, patient component of respiratory rate RRpt 842, and ventilator component of respiratory rate RRv 844, makes it easy to perceive that the total respiratory rate has no patient component and is entirely comprised of a ventilator component. One also easily sees, due to the vertical arrangement of the boxes, that the patient center column has zeros for all parameters, showing that the patient contribution is negligible and that all of the ventilation totals are due to the ventilator.

The next higher integration level is the trend level. The trend display relates the available data to temporal information in order to show the state of the physiologic process over time. The goal of the trend display is to provide integration that relationally represents trend and qualitative (e.g. rate of change and direction of change) information. All available data is organized in physiological groups that are related through known quantitative and physiological relationships. A particular advantage may be obtained in some embodiments from trending higher order calculated parameters.

The trend display integrates acquired and calculated patient medical parameters related to a particular physiologic process with qualitative (rate of change and direction of change) information by graphically presenting the patient medical parameters in relationship to their associated time values. It provides organization for all available data within a physiological group, as related through known quantitative relationships. Formulae may optionally be shown, with a simple data box on left and the trend on right, including alarm boundaries. Conventions for showing intermittent data and that certain parameters are unavailable will preferably be followed. The trend display shows graphical trends of either single parameters or derived parameter values based on a formula using several parameters. Each graphical trend may be preceded by a data box containing the current value of the trended parameter. In the preferred embodiment, the trend display does not just display trends for each parameter, but rather brings out higher order relationships between parameters. This permits change information to be interpreted in the context of the other aspects of the relevant physiologic process.

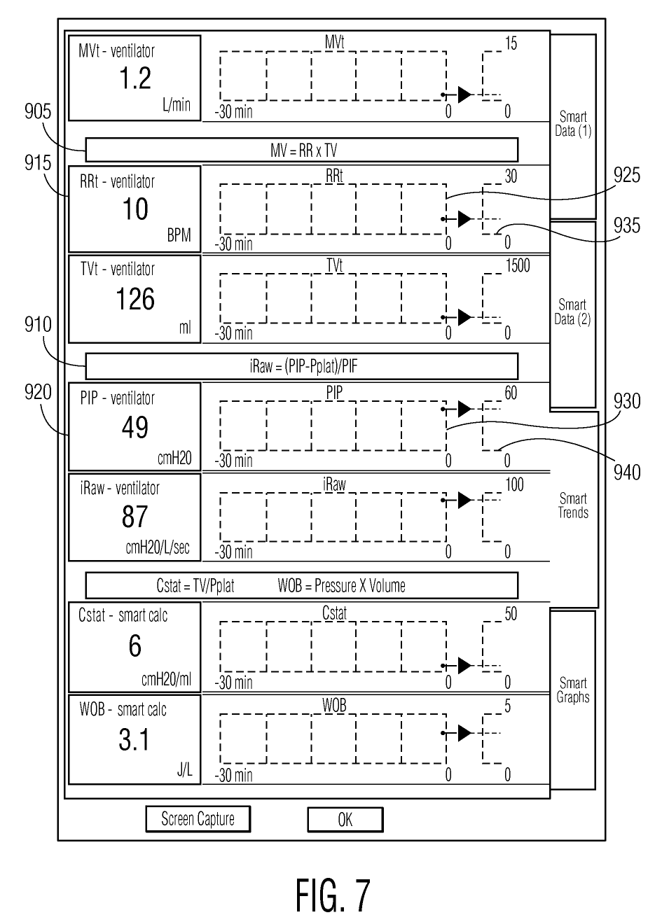

FIG. 7 is an example of a trend display for ventilation, again during the occurrence of a bronchospasm event. In FIG. 7, formulae 905, 910 for calculating the values being trended are shown above the relevant data, with simple data boxes 915, 920 presenting current value on the left and trend graphs 925, 930 on the right, including alarm boundaries 935, 940. Intermittent data, if present, is indicated by use of elapsed time, # sign, and font change to italics. When data is unavailable, this is indicated by the use of dark grey on black for all scale and labeling. Optimally, values, scale values, and labels are visible from a distance of at least 6 meters. The values over a time interval selected by the user are displayed and the resolution of the data, the sampling rate, is made visible.

The highest level of data integration is provided by the graphical display. The graphical display presents a graphical view that indicates a physiological state of a patient with respect to a particular physiological process and allows relationships and patterns that are clinically relevant to be seen easily, such as, for example, but not limited to, saturation of red cells, vascular tone (e.g., constricted or dilated), and heart status (e.g., RV and LV preload). The information on the graphical display may be derived from one or more patient medical parameters that are presented on the corresponding data display and trend display. Preferably, the background of the graphical display orients the user to the physiological area and supports the user's ability to see how different organ systems participate in the physiology of interest. Data is presented in the context of multidimensional relationships. As with the lower level displays (data and trend), rules are preferably implemented to handle intermittent and/or missing data. Preferably, shapes, scale values, and labels are visible from a distance of at least 6 meters. In a preferred embodiment, the graphical display shows clinically relevant conditions only. This prevents clutter, because parameters are not shown when they are not of interest.

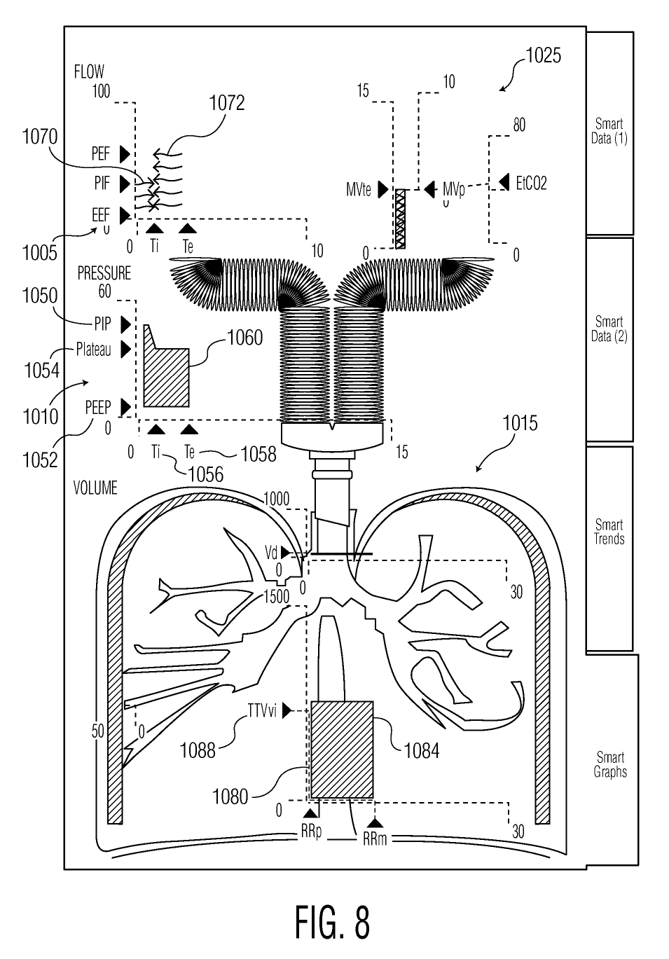

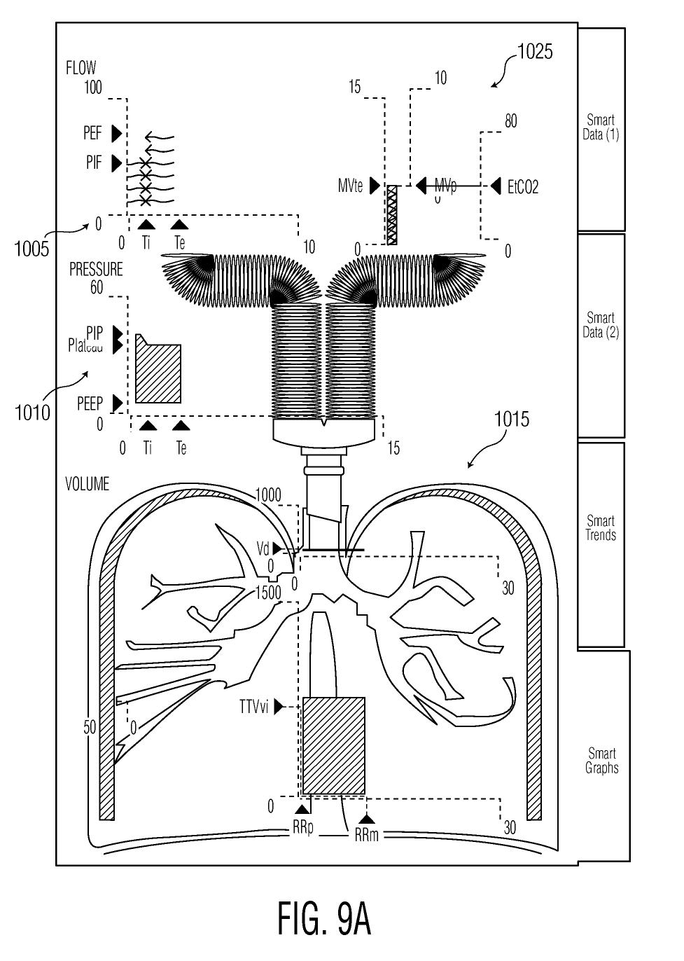

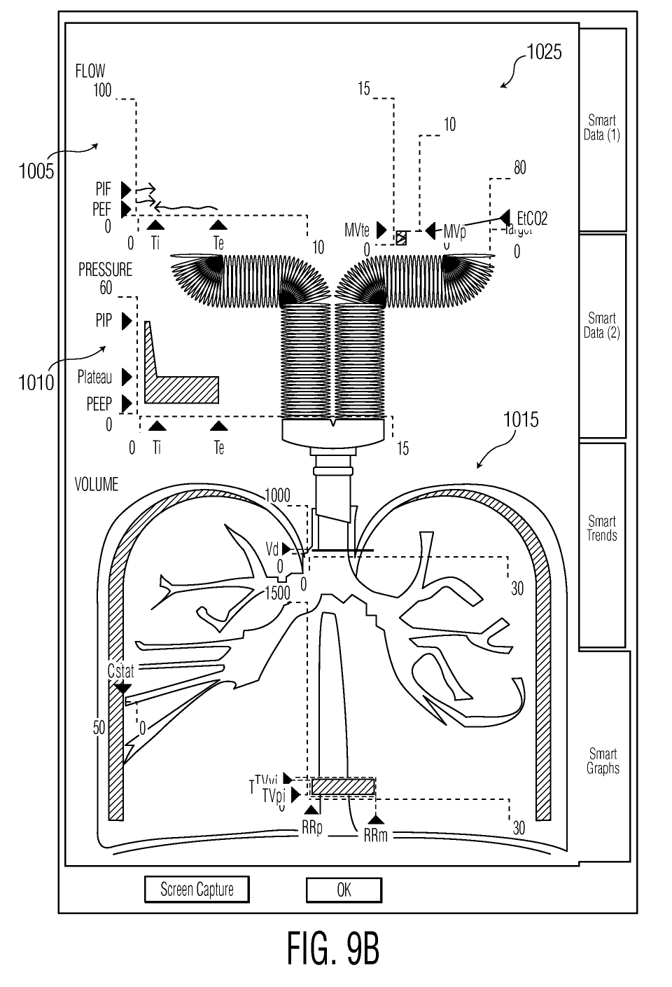

FIG. 8 is an example embodiment of a graphical display for ventilation, depicting the baseline before a bronchospasm event, according to an aspect of the present invention, while FIGS. 9A-B depict the same graphical display during the bronchospasm event. In this embodiment, a set of graphical relational objects have been created and implemented for the ventilation system. This display presents several lung parameters in a single display. The parameters include tidal volume inspiration mechanical, tidal volume inspiration patient, tidal volume expiration mechanical, tidal volume expiration patient, average inspiration tidal volume, average expiration tidal volume, patient respiration rate, mechanical respiration rate, dead space, and compliance. This display depicts five related graphical objects: flow object 1005, pressure object 1010, volume object 1015, compliance object 1020, and global ventilation object 1025.

In compliance object 1020, compliance is shown as rim 1030 in the shape of a lung that is thick when the compliance is reduced and thin when the compliance is normal.

Global ventilation object 1025 displays the volume parameters of a ventilated patient. The parameters displayed are ventilator minute volume, patient minute volume, and total minute volume. This information is displayed in relation to target and patient EtCO2. Global ventilation is adequate or inadequate based on the measured carbon dioxide in the blood or eliminated in exhaled gases. The total minute ventilation (Mv), patient and ventilator contributions, and observed/measured CO2 relative to the target goal is established as a dynamic scale with a line that allows ventilation to be seen as too little vs. too much. This embodiment shows machine, patient, and total (aggregate ventilation) in 3 different boxes (one for each).

Pressure object 1010 presents the pressure parameters of a ventilated patient. The parameters displayed are PIP 1050, PEEP 1052, and Plateau 1054 on the y-axis and Inspiration Time (Ti) 1056 and Expiration Time (Te) 1058 on the x-axis. Pressure information is shown as dynamic graphic 1060 in which peak inspiratory pressure and positive end expiratory pressure, along with plateau pressure, create a resistor. The length of the resistor along the x-axis is set by the time for one breath (I and E). A narrowed tube represents airway resistance due to conditions such as bronchospasm or a kinked endotracheal tube. Positive pressure breaths are shown as positive pressures and spontaneous breaths are shown as negative pressures. The zero point on the pressure scale is not at bottom of scale, but rather is moved to the midpoint, permitting indication of negative pressure during spontaneous inspiration. This breaks out the ventilator vs. the patient contributions.

Medical data related to patient inspiratory and expiratory flows is shown cognitively in flow object 1005, which is comprised of a set of inspiratory objects 1070 and a set of expiratory objects 1072. In this embodiment, inspiratory objects 1070 and expiratory objects 1072, are curved arrows pointing right and left corresponding to patient inspiratory (I) and expiratory (E) flows, respectively. The length of an arrow maps onto the inspiratory or expiratory time. The relative proportion of inspiratory and expiratory lengths maps to the I:E ratio. In other words, the x-axis is dynamically segmented into inspiratory and expiratory segments thus allowing one to visually perceive the I:E ratio.

Preferably, each arrow represents a standard unit, with more arrows meaning increased flow. FIG. 8, in which each arrow represents approximately 10 liter per minute flow, depicts flow inspiration of about 30 liters per minute and flow expiration of about 50 liters per minute.

Medical data related to patient inspiratory and expiratory volumes is shown in volume object 1015, which is comprised of an inspiratory volume object, an expiratory volume object, and a leak volume object. Volume object 1015 determines and graphically displays the difference between the delivered flow on the inspiration side and the measured flow on the expiration side. Flow and pressure define the volume of gas moving into the patient's lungs. Volume information is represented by a box with a height that corresponds to the volume and a width that is bound on the left by the value of RRp and on the right by RRm. Subdivided volumes for ventilator and patient contributions are both shown. Volumes for Patient, Ventilator, and Total are shown, along with the respiratory rate associated with each. Transparency is used to differentiate the three boxes that represent the three volumes.

Any discrepancy between expiratory and inspiratory is shown by the leak volume object as a difference between the shaded and unshaded parts, i.e., between the inspiratory volume object and the expiratory volume object, of box 1080, which is normally solid (preferably white) when they are the same. This allows graphic display of leak volume. In the preferred embodiment, this difference is shown as area 1084, which is preferably red, indicating the presence of an alarm condition. Masking of inspiratory and expiratory volumes occurs via a prioritization formula, so that the inspiratory volume object is normally shown on top of the expiratory volume object. Only if the expiratory volume is less than the inspiratory volume in a relevant amount does the difference show. As expiratory volume drops with respect to inspiratory volume, the red warning area, i.e., the leak volume object, is exposed, and serves to represent the leak volume. Similarly, inspired label 1088 masks the tidal volume expired label, except when there is a leak.

In a preferred embodiment of the graphical display of the present invention, as with the data and trend displays, a particular advantage is conferred by rules that handle situations when parameter data is lost, such as might happen when a sensor is unplugged or turned off, or a continuous signal becomes intermittent or ceases altogether. Objects go from solid fill to hatched, graphs go from solid line to dashed, parameters have “#” put in front to start and then grayed out after a predetermined duration of time, e.g., 15 minutes. Images and lines can also be dashed and/or grayed out in graphical displays, as in the data and trend displays. Italics can be used to show when data goes from continuous to intermittent as a cue to which data is fresh v. old. Elapsed time may be displayed in order to indicate how old data is.

In one preferred embodiment, each graphical object is defined in an optional overview display. For example, in the example embodiment of FIGS. 4A-B, tab 615 allows access to a graphical display that provides an overview of the graphical icons that represent the physiological state of the underlying system. One skilled in the art will recognize that accessing the overview display is possible through a variety of alternate display features other than a tab. For example, a hyperlink displayed on the user interface may provide such access.

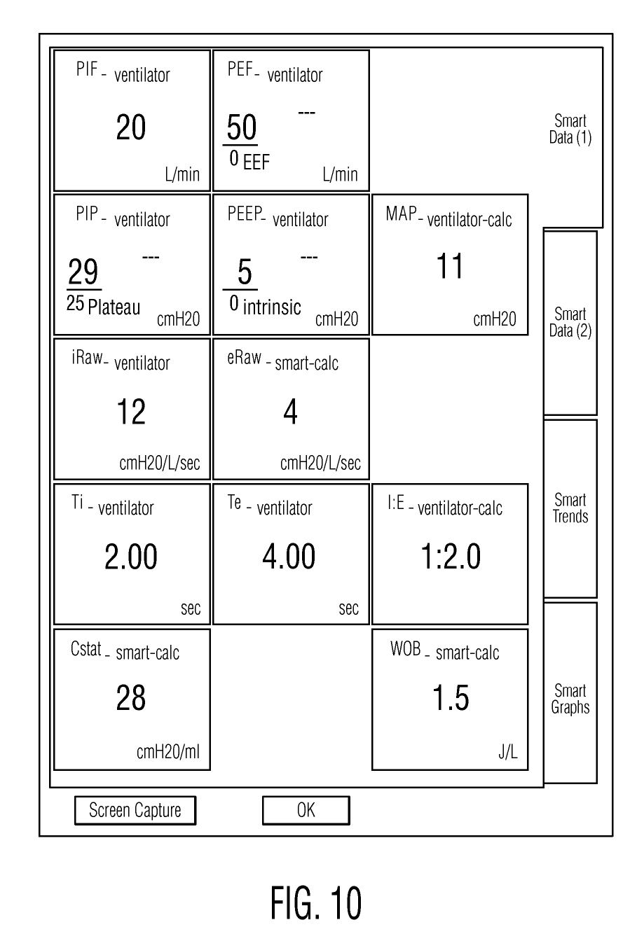

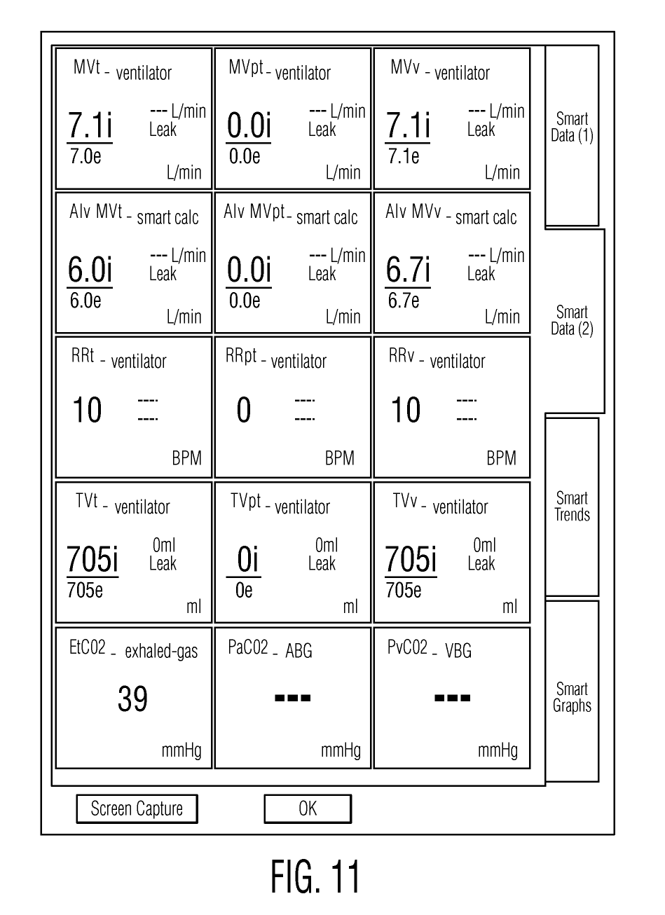

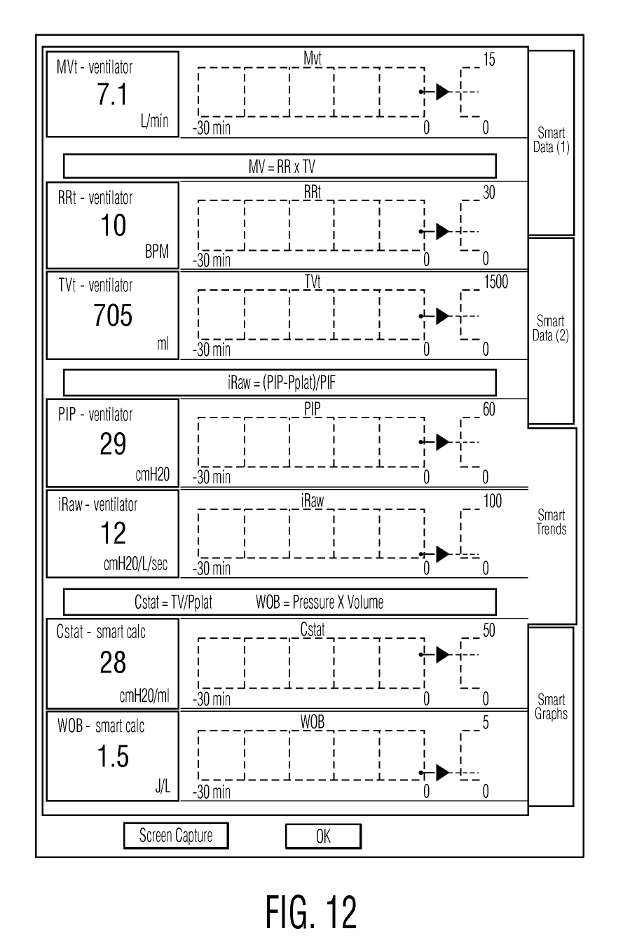

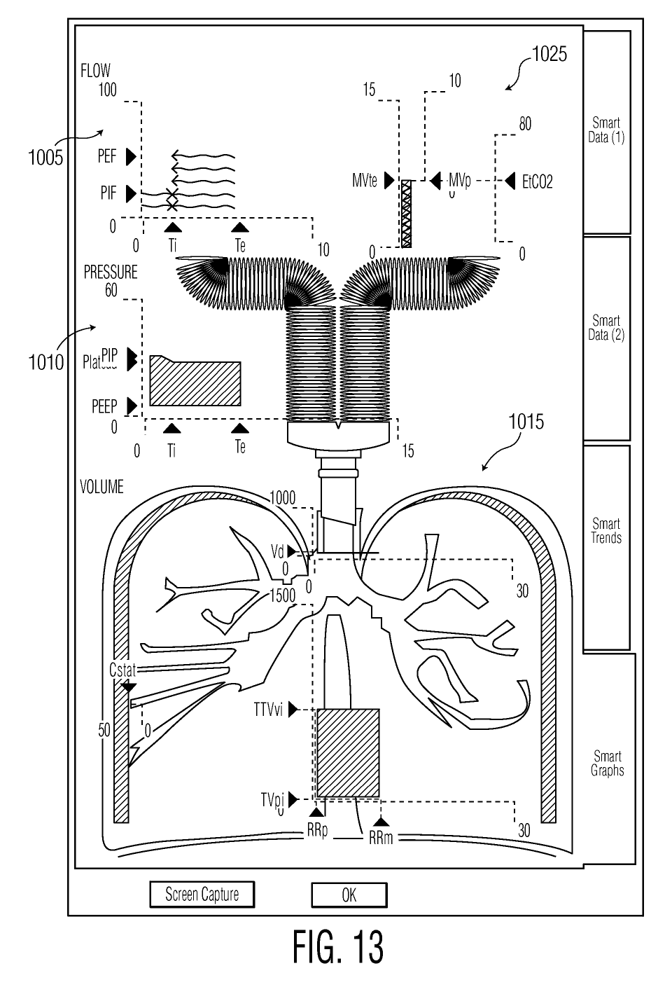

In another example, FIGS. 10-13 depict example embodiments of a display set for ventilation, according to an aspect of the present invention.

It will be clear to one of skill in the art that additional information may optionally be displayed in conjunction with the data display of the present invention. For example, a list of patient monitoring parameters may optionally be displayed.

Alternatively, or additionally, real-time “raw signal” results 1610 being received from one or more monitoring devices may be displayed to the right of the data display 1620, as shown in FIG. 14, which is an example embodiment of a data display for perfusion according to the present invention. In particular, this embodiment permits artifact detection and provides signal quality information, since viewing the analog signal of a given data channel can provide a great deal of information about artifacts and quality of the signal. This allows the user to check whether a detected change or anomaly is real or just noise. Pop-up windows next to the data pointers may also be available, similar to the trend windows, in order to allow noise or artifacts to be detected.

Other useful features provided by the trend display may include, but are not limited to, normalization of information and patient disease information. Due to inter-patient variability and changing patient physiologic state in settings like surgery, the definition of what is normal effectively changes. Normalization of information provides that the values that represent frames of reference can be re-sized and re-scaled on command. Data can be normalized with respect to the individual patient's normal state and boundaries set accordingly (thereby setting the baseline for an individual patient). For example the “normal” SVR may default to 1000, which is the 3 o'clock position, however if a patient is normally 2000 then this function allows the meter scale to be reset, positioning 2000 at 3 o'clock. Data regarding disease states may optionally also be saved if desired, in order to allow boundary defaults to be reset. For example, hypertension shifts the autoregulatory curve to the right, so many doctors keep the blood pressure settings at a higher range than usual.

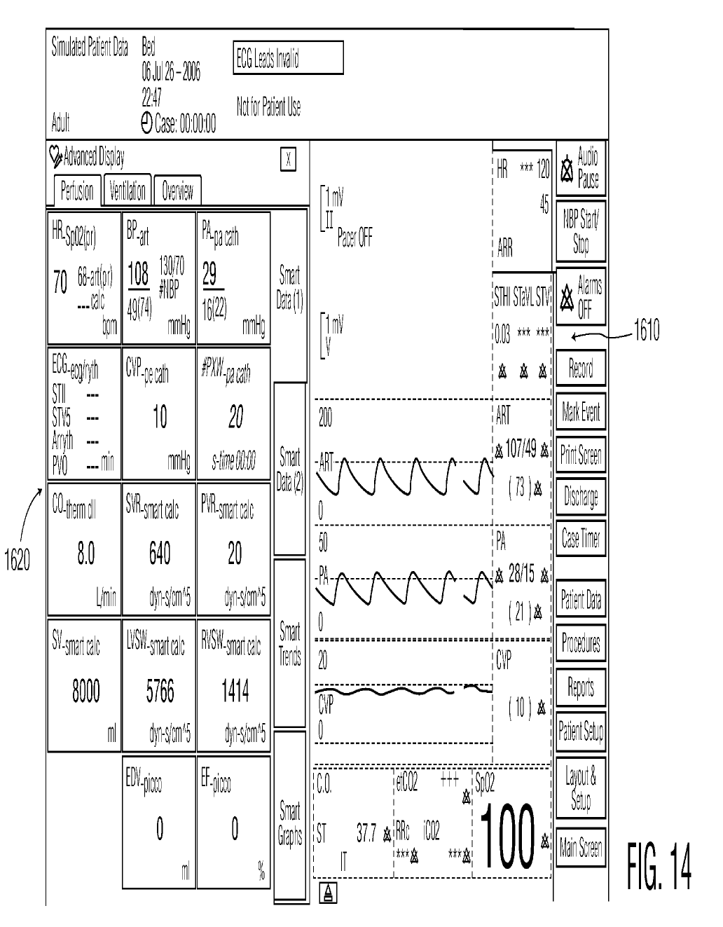

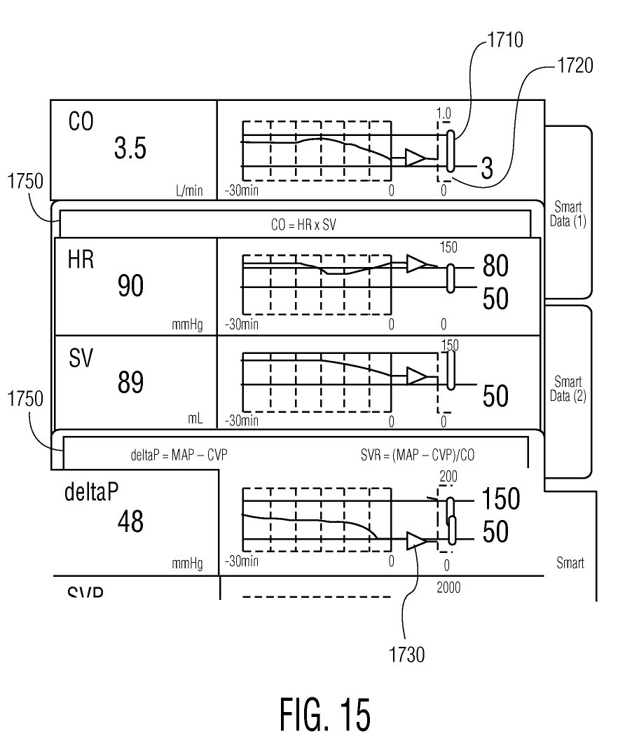

In one aspect, the trend display provides boundary information. FIG. 15 depicts an example embodiment of a trend display, presenting temporal and qualitative information in line graph format. Scales have normal 1710 and abnormal 1720 zones (shown, e.g., as black and yellow bars). Pointers 1730 are used to display current values. Formulae 1750 used for calculating the trended parameter may optionally be shown, e.g. Ohm's Law of Fluid Flow (CO=HR×SV).

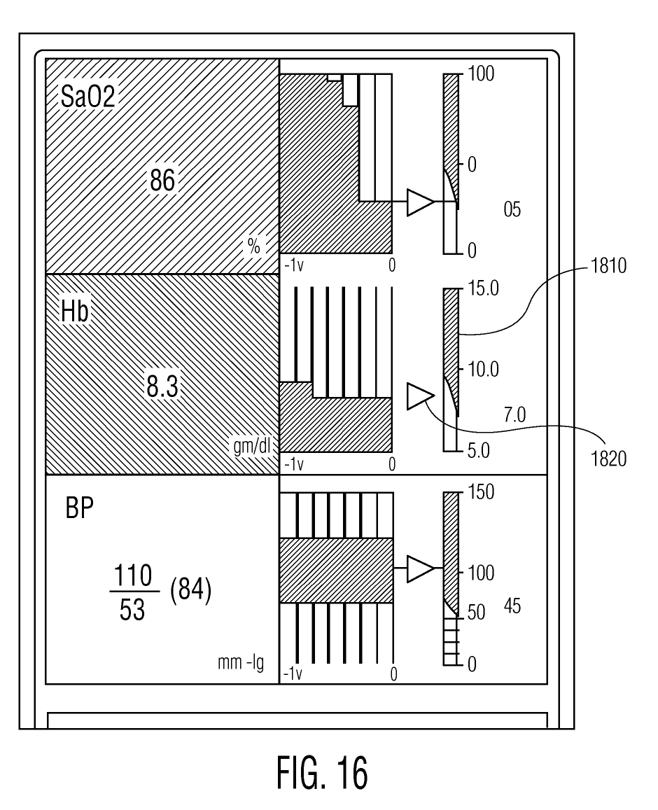

FIG. 16 depicts a trend display designed to clearly indicate when the value of a parameter has entered a predetermined warning or alert zone 1810 for that parameter. The alert zones parameter is optionally user-settable, permitting the user to set the value above or below the critical thresholds at which they wish to be alerted. When the alert zone is entered, pointer 1820 may also be designed to change color or start flashing in a graded fashion, such that the brighter the red color of pointer 1820, the closer to the threshold the value is.

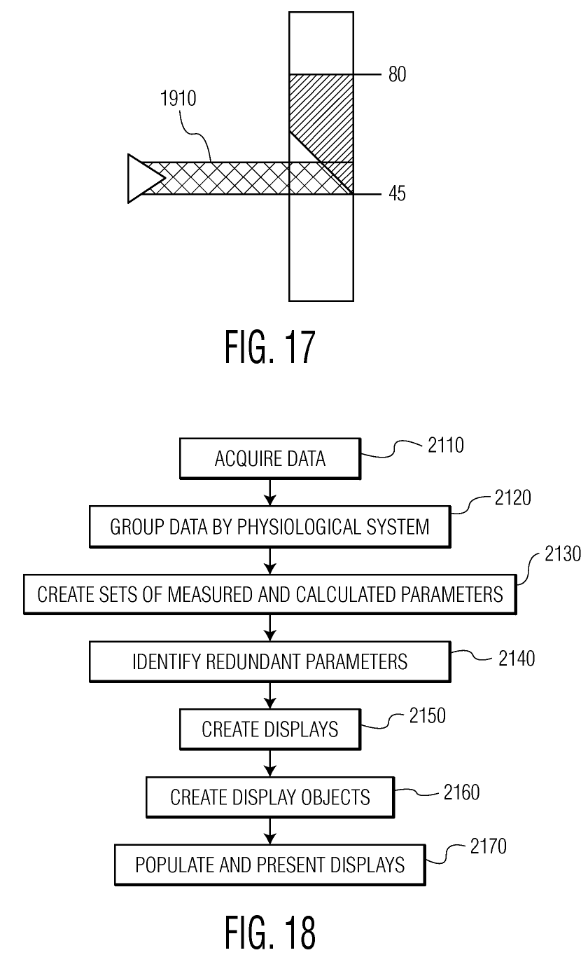

In another aspect, the trend display provides confidence interval information. “Fuzzy” graphical representations allow the precision and bias of a measured data channel (when it is known), to be shown. FIG. 17 is a trend display that depicts ± confidence interval information. In FIG. 17, pointer tip 1910 is designed to be centered on the appropriate value but also to have a thickness which represents the known error associated with that datum. This creates a pointer that changes color and enter danger zones based on the “worst” case scenario. This fuzzy logic recognizes that clinicians do not consider conditions such as hypertension, hypotension, or brachycardia as discrete boundary crossings, but instead as relative limits in which the patient is in a state that has a probabilistic risk associated with it. For example, current alarms for heart rate might be set at 80. In a standard system, a heart rate of 81 would cause an alarm, as being an upper limit for a patient with coronary artery disease, while a heart rate of 79 would not. Clearly, clinicians would rather be cued when the heart rate is in the 70's and climbing. This permits superior management of this type of patient's risk of developing ischemia intraoperatively.

FIG. 18 is a flowchart depicting an embodiment of the overall processing and derivation steps employed in presenting patient parameters via an embodiment of the system of the present invention. In FIG. 18, all available datum are gathered 2110 and grouped by physiological system 2120. Sets of parameters are created and additional parameters calculated 2130, and redundant parameters identified 2040. The different types of displays of datum are created 2150, from least integrated and least informative to most integrated and most informative. Display objects are created 2160, such as data boxes, trends, graphical objects, and then used to populate 2170 the dynamic display screens.

In the process of deriving the data relationships in order to organize the display, all available data parameters are organized by physiological group. Groups are sorted into subgroups that are the same (typically same datum, different source). The total parameters for specific physiology are broken into boxes, in order to group datum that are clinically used together. This may be implemented as a rules-based process. It will be clear to one of skill in the art that, while it is advantageous to dynamically determine the layout of data boxes and of parameters within data boxes for the data display, according to any criteria determined to be useful, including, but not limited to, the sources of data available and the accuracy of those sources, the present invention may also be implemented with a fixed layout of data boxes or arrangement of the parameters within one or more of the data boxes.

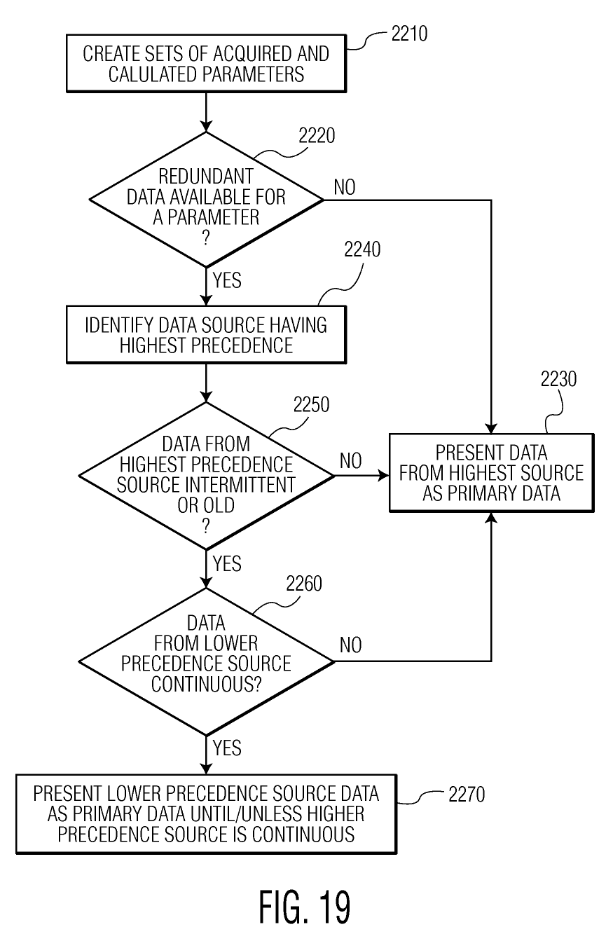

FIG. 19 is a flowchart depicting a specific example embodiment of the dynamic processing and derivation steps that may be employed in dynamically presenting patient parameters via an embodiment of the data display of the present invention. In FIG. 19, parameters are organized into sets 2210. If redundant data is not available for a parameter 2220, then the data available is presented 2230 as the primary data. If, however, redundant data is available 2220, then the data source having the highest precedence is identified 2240. If the data from the highest precedence source is continuous (not intermittent or old), it is presented 2230 as the primary data. However, if it is not continuous, the data obtained from the lower precedence source will be considered 2260. If it is not continuous either, then the data from the highest precedence source is used 2230. However, if it is continuous, then the data from the lower precedence source is presented as the primary data 2270 until and/or unless the higher precedence source becomes continuous. It will be clear to one of skill in the art that, while a specific example is presented in FIG. 19 of dynamic decisions made on the basis of the continuity of the redundant sources, many other criteria could be advantageously applied in the same way to dynamically promote a source to or from being the primary data source, and similarly that many other dynamic decisions regarding the arrangement of the display may be made using the same process.

In a preferred embodiment, the present invention is implemented as a software application implemented in the C++ language using Microsoft Foundation Class (MFC) libraries that runs on a general-purpose computer executing Microsoft Windows. However, it will be clear to one of skill in the art that the invention may also be implemented in firmware, hardware, or any combination of software, firmware, and/or hardware. While specific platforms, operating systems, languages, and/or software packages are described, it will be clear to one of ordinary skill in the art that many other platforms, processors, operating systems, languages, and/or software packages are suitable and may be advantageously employed with or on the present invention.

In a current prototype implementation, the displays are implemented as OLE Control Extension (OCX) modules that are called via horizontal or vertical side tabs. Each horizontal tab (physiologic process display set) is implemented as a separate OCX module. The arrangement of data boxes and the parameters displayed within them are defined by Extensible Markup Language (XML) configuration files. The configuration file defines the type of parameter box display, parameter or parameters, data source, display name, and units. Separate XML files are used for each data display. Similarly, the setup of the trend display is defined by a trend configuration XML file.

An executable application as used herein comprises code or machine readable instruction that is compiled or interpreted for implementing predetermined functions including those of an operating system, healthcare information system, or other information processing system, for example, in response to user commands or input. An executable procedure is a segment of code (machine readable instruction), subroutine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one, or combination of, hardware, firmware, and/or software. A processor acts upon information by manipulating, analyzing, modifying, converting, or transmitting information for use by an executable procedure or information device, and/or by routing the information to an output device. A processor may use or comprise the capabilities of a controller or microprocessor, for example. A display processor or generator is a known element comprising electronic circuitry or software or a combination of both for generating display images or portions thereof. A display processor may generate a display image based on the values of data contained in a corresponding data object. A user interface comprises one or more display images enabling user interaction with a processor or other device and associated data acquisition and processing functions.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

1. A system for deriving and displaying relationships among patient medical parameters, the system comprising:
a data acquisition processor for acquiring a plurality of patient medical parameter values from different sources, the acquired patient medical parameters being related to a particular physiological process;
a data processor for calculating derived patient medical parameters related to the particular physiological process from the acquired patient medical parameter values and for applying precedence rules to the acquired and derived patient medical parameters, the precedence rules establishing priority of the sources depending on reliability of the sources; and
a display for displaying the acquired and derived medical patient medical parameter values according to the established priority of the sources, with the source with the highest priority being displayed as primary source.

2. The system of claim 1, wherein the priority of the displayed sources is dynamically established during operation of the system.

3. The system of claim 1, wherein data from a lower priority source is dynamically promoted or demoted in position on the data display when data from a higher priority source becomes absent or present, respectively.

4. The system of claim 1, wherein medical data values for the same medical data parameter received from different sources are displayed in a mutually adjacent manner, with a data value from a higher priority source being placed in a higher priority position.

5-6. (canceled)

7. The system of claim 1, wherein the reliability of the sources is determined from at least one of predetermined confidence intervals, accuracy of data derived from the source, continuity of data derived from the source, availability of a source having higher priority, and non-availability of a source having higher priority.

8. The system of claim 1, the display further comprising:
at least one data display for presenting at least some of the acquired and derived patient medical parameter;
at least one trend display for graphically presenting a plurality of values of at least one acquired or derived patient medical parameter associated with a plurality of time values; and
at least one graphical display, comprising at least one graphical object, for indicating the physiologic state of a patient with respect to the particular physiological process, information presented via the graphical display being derived from at least one of the acquired and derived patient medical parameters.

9. (canceled)

10. The system of claim 8, wherein trend graphs for display on the trend display and graphical objects for display on the graphical display are dynamically created or modified by the data processor.

11-13. (canceled)

14. The system of claim 1, wherein the patient medical parameter values comprise both acquired and calculated parameters.

15-17. (canceled)

18. A method for deriving and displaying patient medical data related to a particular physiological process, the method comprising:
acquiring, from different sources, a plurality of patient medical data related to a particular physiological process;
deriving calculated patient medical data from at least some of the acquired patient medical data;
applying precedence rules to the acquired and calculated patient medical data, the precedence rules establishing priority of the sources depending on reliability of the sources; and
presenting the acquired and calculated patient medical data on a data display screen according to the established priority of the sources, with the source with the highest priority being displayed as primary source.

19. The method of claim 18, further comprising the step of displaying different values received from different sources for the same patient medical data in mutual proximity, with the data from the higher priority source being placed in a higher priority position.

20. The method of claim 19, further comprising the step of dynamically promoting or demoting data values received from a lower priority source to a higher or lower priority position on the data display when data from a higher priority source becomes absent or present, respectively.

21. A system for obtaining and deriving medical data related to patient inspiratory and expiratory flows and for displaying the data, the system comprising:
a data acquisition processor for acquiring patient medical data from a ventilator;
a data processor configured to map the medical data onto a flow data object; and
a display for displaying the flow data object, the flow data object comprising at least one set of inspiratory objects formed as arrows pointing in a first direction and displaying information representative of the inspiratory flow, and at least one set of expiratory objects formed as arrows pointing in a second direction and displaying information representative of the expiratory flow.

22. (canceled)

23. The system of claim 21, wherein each arrow represents a flow rate unit and the number of arrows in each set indicates a flow rate.

24. A method for obtaining and deriving medical data related to patient inspiratory and expiratory flows and displaying the data, the method comprising:
acquiring from a ventilator, patient medical data related to the inspiratory and the expiratory flow;
mapping the patient medical data onto a flow data object; and
displaying a flow data object on a display, the flow data object comprising at least one set of inspiratory objects formed as arrows pointing in a first direction and displaying information representative of the inspiratory flow, and at least one set of expiratory objects formed as arrows pointing in a second direction and displaying information representative of the expiratory flow.

25. (canceled)

26. The method of claim 24, wherein each arrow represents a flow rate unit and the number of arrows in each set indicates a flow rate.

27. (canceled)

28. (canceled)

29. The system of claim 18, wherein the reliability of the sources is determined from at least one of predetermined confidence intervals, accuracy of data derived from the source, continuity of data derived from the source, availability of a source having higher priority, and non-availability of a source having higher priority.
